(19) United States
(12) Patent Application Publication
(10) Pub. No.: US 2018/0018746 A1
(43) Pub. Date: Jan. 18, 2018

(54) SYSTEM AND METHOD FOR MONITORING CLASS ATTENDANCE

(71) Applicant: Core Principle, Inc., Indianapolis, IN (US)

(72) Inventors: John Frank WHORLEY, JR., Indianapolis, IN (US); Joseph Wade MONTGOMERY, Indianapolis, IN (US)

(21) Appl. No.: 15/718,816

(22) Filed: Sep. 28, 2017

Related U.S. Application Data
(63) Continuation of application No. 14/529,675, filed on Oct. 31, 2014.
(60) Provisional application No. 61/897,906, filed on Oct. 31, 2013.

(51) Int. Cl. G06Q 50/20; G06Q 10/10; H04W 4/02

(52) U.S. Cl. CPC G06Q 50/205; H04W 4/028; G06Q 10/1095; H04W 4/021

(57) ABSTRACT

A system for monitoring class attendance includes a database, an attendance detection mobile application, and a processor. The database stores a profile for a student including a mobile device identifier for a mobile device, and a class schedule including a class identifier, a scheduled date, a scheduled time, and a class location. The attendance detection mobile application is installed on the mobile device, and obtains and transmits a mobile device location in response to a device location request. The processor is in electronic communication with the database and the mobile device and is configured to monitor the class schedule, and, at the scheduled date and time, request a mobile device location from the mobile device using the mobile device identifier. The processor compares the mobile device location to the class location, and, as a result, stores an attendance status corresponding to the class identifier and the student in the database.

### CROSS-REFERENCE TO RELATED APPLICATIONS

This application is a continuation of U.S. patent application Ser. No. 14/529,675, filed Oct. 31, 2014, which claims the benefit of U.S. Provisional Patent Application No. 61/897,906, filed Oct. 31, 2013, the entireties of which are hereby incorporated herein by reference. Any disclaimer that may have occurred during the prosecution of the above-referenced applications is hereby expressly rescinded.

### TECHNICAL FIELD

The present disclosure relates generally to a system and method for supporting, monitoring, and summarizing class attendance, such as college class attendance, and more specifically to electronically monitoring class attendance and reporting a class attendance status for a student to an interested party.

### BACKGROUND

Many people have a stake in the academic success of students, including parents, instructors, coaches, and, most importantly, the students themselves. Common predictors of academic success include aptitude tests, previous academic success, study skills, and time devoted to studying, to name a few. Although class attendance is generally recognized as an additional predictor of academic success, some research has shown class attendance to be a better predictor of grades than some of the other commonly observed predictors. In fact, research supports the contention that class attendance is a critical driver of student retention, persistence to graduation and, more generally, student success.

Acknowledging the link between class attendance and student success, some college campuses manually and aggressively monitor attendance, particularly for scholarship athletes. For example, at several institutions, if a scholarship athlete is absent at the beginning of class, the instructor, or other person working under the direction of the athletic department, may take immediate action to locate the student. According to some studies, such measures have been linked to relatively higher rates of academic success as compared to the general student population. Manually monitoring class attendance, however, requires substantial time and resources, making it a challenging retention strategy for many institutions.

More recently, automated attendance monitoring systems have been introduced. For example, U.S. Pat. No. 8,353,705 to Dobson et al. is directed to a system and method for gathering and validating attendance data, and discloses the use of identification tags, such as RFID tags, that are carried by students and scanned by a scanner as the students enter a classroom. The Dobson et al. reference also discloses the creation of a provisional attendance report, based on the scanned tags, which may be reviewed for accuracy and modified. There remains a need, however, for alternative and/or improved attendance monitoring strategies.

The present disclosure is directed to one or more of the problems or issues set forth above.

### SUMMARY OF THE DISCLOSURE

In one aspect, a system for monitoring class attendance using a mobile device of a student includes a database, an attendance detection mobile application, and a processor. The database stores a profile for the student including a mobile device identifier for the mobile device, and a class schedule that includes a class identifier, a scheduled date, a scheduled time, and a class location. The attendance detection mobile application is installed on the mobile device, which includes location detection hardware. The attendance detection mobile application obtains and transmits a mobile device location in response to a device location request. The processor, which is in electronic communication with the database and the mobile device, is configured to monitor the class schedule, and, at the scheduled date and the scheduled time, request the mobile device location from the mobile device using the mobile device identifier. The processor then compares the mobile device location to the class location, and stores an attendance status corresponding to the class identifier and the student in the database based on the comparison.

In another aspect, a method for monitoring class attendance using a mobile device of a student includes a step of storing a profile for the student that includes a mobile device identifier for the mobile device, and a class schedule that includes a class identifier, a scheduled date, a scheduled time, and a class location in a database. The method also includes steps of monitoring the database using a processor that is in electronic communication with the database and the mobile device, and, at the scheduled date and the scheduled time, transmitting a request for a mobile device location from the processor to the mobile device using the mobile device identifier. The mobile device obtains the mobile device location in response to the request and transmits the mobile device location to the processor. The processor compares the mobile device location to the class location, and an attendance status corresponding to the class identifier and the student is determined based on the comparison and stored in the database.

In yet another aspect, a system for monitoring class attendance for a plurality of students includes a database storing a profile for each of the plurality of students. Each profile includes a mobile device identifier for a mobile device and a class schedule including a class identifier, a scheduled date, a scheduled time, and a class location. The system also includes an interested party user device including a GUI displaying an attendance summary dashboard providing attendance status data for at least one of the plurality of students. A processor is in electronic communication with the database, the interested party user device, and the mobile device of each of the plurality of students. The processor monitors the class schedules of the plurality of students, and, at the scheduled dates and scheduled times, requests mobile device locations from the respective mobile devices using the mobile device identifiers. The processor compares the mobile device locations to the class locations, determines and stores attendance status data corresponding to the class identifiers and the students in the database based on the comparisons, and communicates the attendance status data to the interested party user device.

### BRIEF DESCRIPTION OF THE DRAWINGS

FIG. 1 is a block diagram of an exemplary system for monitoring class attendance, according to the present disclosure;

FIG. 2 is an exemplary screen display representing a user interface for inputting registration information into the system of FIG. 1;

FIG. 3 is a flow diagram representing a first exemplary method of monitoring class attendance using the system of FIG. 1, according to one aspect of the present disclosure;

FIG. 4 is a diagrammatic view of a college campus, depicting a virtual perimeter representing a classroom location and device locations for two different student mobile devices, as referenced by the first exemplary method of FIG. 3;

FIG. 5 is a flow diagram representing a second exemplary method of monitoring class attendance using the system of FIG. 1, according to another aspect of the present disclosure;

FIG. 6 is an exemplary screen display representing a user interface for inputting class attendance, according to the second exemplary method of FIG. 5;

FIG. 7 is a first exemplary dashboard display of an exemplary user interface for conveying an attendance summary, according to another aspect of the present disclosure;

FIG. 8 is a second exemplary dashboard display of an exemplary user interface for conveying an attendance summary, according to another aspect of the present disclosure;

FIG. 9 is a third exemplary dashboard display of an exemplary user interface for conveying an attendance summary, according to another aspect of the present disclosure; and

FIG. 10 is a fourth exemplary dashboard display of an exemplary user interface for conveying an attendance summary, according to another aspect of the present disclosure.

### DETAILED DESCRIPTION OF THE ILLUSTRATED EMBODIMENTS

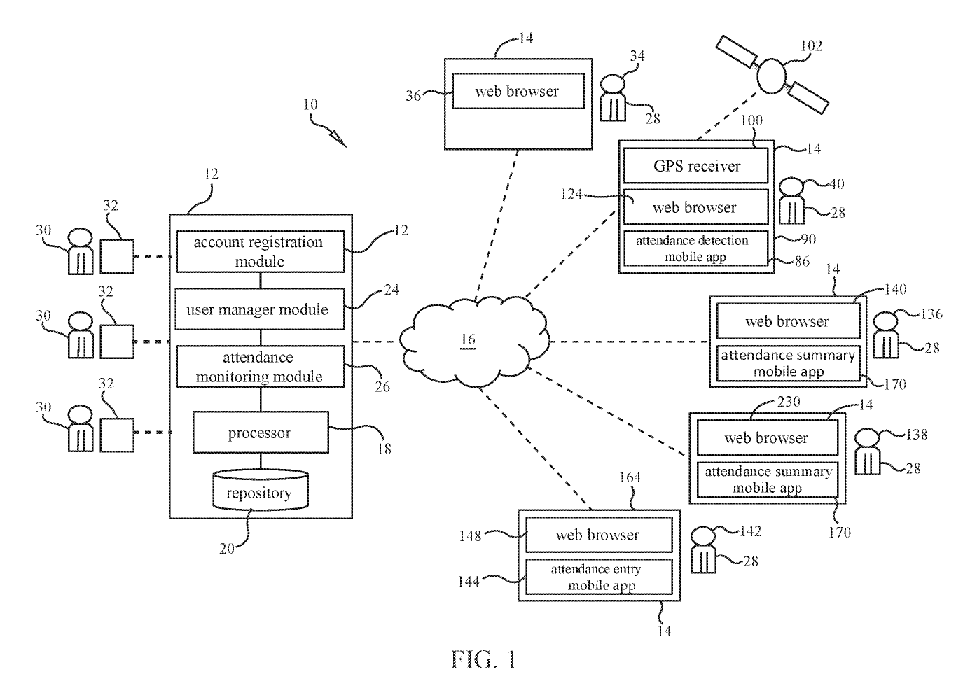

FIG. 1 illustrates an exemplary system 10 for monitoring class attendance, according to the present disclosure. The attendance monitoring system 10 may generally include a server 12, or server system, and a plurality of user devices 14, or client devices or systems, coupled to communicate through a network 16 and/or coupled through communication links that allow information to be exchanged using conventional communication protocols and/or data port interfaces. That is, the server 12 and user devices 14 may communicate, or receive and transmit data, through the network 16 with each other using wired and/or wireless communication schemes. The network 16 may include a local area network, a wide area network, an intranet, and/or the Internet, for example. Although the attendance monitoring system 10 is shown communicating through a single network 16, it should be appreciated that multiple networks may be utilized to facilitate direct and/or indirect electronic communication between the server 12 and one or more of the user devices 14.

The server 12, or set of servers, may include one or more computers having one or more processors, such as processor 18, memory, storage, a display, a network interface, and an input/output device, for example. The processor 18, or processors, may execute unique sets of instructions, which may be implemented as computer readable program code, stored in memory or storage, such that the server 12, or server system, is configured as a special purpose system. In particular, hardware, software, and particular sets of instructions transform the server 12 into the attendance monitoring system 10, or portions thereof. As should be appreciated by those skilled in the art, the server 12 may include, in addition to the hardware components, an application layer and an interface layer that may include or provide a variety of user interfaces, including a web user interface and a graphical user interface, permitting direct or indirection interaction between the attendance monitoring system 10 and the user devices 14.

A portion of the server 12, or server system, may be configured using a solution stack that generally includes an operating system, a web server, a database management system, and scripting languages. According to one example, portions of the attendance monitoring system 10 may be configured using a LAMP solution stack, which includes a Linux operating system, an Apache web server, MySQL database software, and PHP scripting languages. According to some embodiments, the attendance monitoring system 10 may further be configured with a content management system and a blogging interface.

As stated above, the attendance monitoring system 10 may include a database management system including one or more databases, such as data repository 20. The data repository 20 may store data useful in carrying out the attendance monitoring strategies disclosed herein. Although the data repository 20 is illustrated as a component within the server 12, it should be appreciated that the server 12, or server system, may include any number of separate components or systems, including separate database(s), configured to communicate with one another in a manner consistent with the teachings disclosed herein.

For reasons that will become more apparent below, the data repository 20 may be initially populated with class location data. The class location data may be geographical location data related to classrooms or meeting locations on college campuses, or other facilities, included in a service area of the attendance monitoring system 10. Such location data may be collected, modified, and/or refined over time. According to one example, geographic coordinates, such as latitude and longitude information, for a particular college campus may be identified and used to generate a virtual perimeter, or geo-fence, designating the college campus. Upon implementation of certain services of the attendance monitoring system 10 at the campus, the class location data may be refined, either manually or automatically, such that a separate virtual perimeter is created and stored for each class room or meeting location of the campus. As such, each class location may include a virtual perimeter bounding a set of geographical coordinates. These separate virtual perimeters may be further refined, or narrowed, over time. Additionally and/or alternatively, the virtual perimeters may be modified, or resized, based on various input.

According to another example, a third party API may be used to assist in determining the class location data. For example, geographical coordinate points for a classroom or building may be determined using a geocoding API, such as the Google Geocoding API or MapQuest Open Geocoding API, for example, which determines geographic coordinates based on address information. In addition, geographic coordinate point data that is associated with classrooms on college campuses may be acquired through third-party API services, including Factual. The geographic coordinates may be used to create the one or more virtual perimeters, or geo-fences, to be used as the class location data. Depending on the perceived accuracy of the address information and/or geographic coordinates for a classroom, for example, the virtual perimeter for each classroom may be expanded to ensure coverage of an entire area, or footprint, of the classroom. Again, acquisition of the class location data is customizable and may be collected and/or refined during operation, or use, of the attendance monitoring system 10.

The attendance monitoring system 10 or, more specifically, the server 12, or server system, may include a plurality of modules useful in carrying out the attendance monitoring strategies disclosed herein. In particular, the server 12 may include or utilize functionality expressed with reference to an account registration module 22, a user manager module 24, and an attendance monitoring module 26. It should be appreciated that the use of the term “modules” is for ease of explanation, rather than limitation, and is intended to represent certain related aspects or functionality of the attendance monitoring system 10. Each of the account registration module 22, user manager module 24, and attendance monitoring module 26 may represent a set of computer instructions, or computer readable program code, representing processes for performing specific tasks of the attendance monitoring system 10. The tasks may be performed using the processor 18, or alternative processors, and may require the access or manipulation of data stored in the data repository 20, or other data storage component.

The account registration module 22, which will be discussed in greater detail below, may facilitate the creation of accounts and/or users within the attendance monitoring system 10. For example, the registration module 22 may be used to collect data input by users 28 and/or administrators 30 accessing the attendance monitoring system 10 through the various user devices 14 or various administrator devices 32. According to some embodiments, the various user devices 14 and administrator devices 32 may include any suitable electronic communication devices and/or workstations, such as, for example, personal computers, laptop computers, netbook computers, mobile devices, cell phones, smart phones, tablet devices, and wearable wireless devices. The account registration module 22 may be used to collect various information, including, for example, personally identifiable information, such as, for example, name, address, and phone number, and billing, or payment, information for one or more services selected for purchase. Additional information, including student information, collected during the registration process will be discussed below.

The user manager module 24 may include and/or implement rules pertaining to the various users 28, or user types, of the attendance monitoring system 10. For example, when one of the users 28 registers for one of the services of the attendance monitoring system 10, a user profile including user credentials, such as a username and password, may be created for the user 28 and stored in the data repository 20. The user manager module 24 may be configured to ensure that each user 28, as identified using the unique credentials, is provided with appropriate access and capabilities with regard to the attendance monitoring system 10, as will be discussed in greater detail below.

The attendance monitoring module 26 may provide the main functionality of the attendance monitoring system 10 with regard to the monitoring of class attendance. For example, after account registration is completed and appropriate users are established in the attendance monitoring system 10, the attendance monitoring module 26 may be programmed and/or configured to monitor and process data from the data repository 20, and/or acquired data, to create, evaluate, and store class attendance information with regard to particular users 28. As will be described below, the attendance monitoring module 26 may also be configured to notify certain other users 28, or third parties, regarding the attendance information collected by the attendance monitoring system 10.

According to an exemplary embodiment, one of the users 28 of the attendance monitoring system 10 may be an interested party user 34, such as, for example, a parent, having an interest in monitoring class attendance for a particular student. The interested party user 34 may access and register with the attendance monitoring system 10 using any device or terminal capable of interfacing with the server 12. For example, the interested party user 34 may register with a user device 14 having web-browsing abilities, such as, for example, a personal computer or a web-enhanced smart device. It should be appreciated that each of the user devices 14 referenced herein may include a processor, memory, storage, a display, a network interface, and an input/device, for example. According to web-enhanced devices, the user device 14 may communicate, or transfer and receive data, with the attendance monitoring system 10 through, for example, internet communication streams, such as an HTTP/HTTPS stream or other protocol stream, such as SMTP or SMS.

Upon requesting a Uniform Resource Locator (URL) address corresponding to a website hosted by the server 12, a web page may be loaded in a web browser 36 of the user device 14 of the interested party user 34. Thereafter, the interested party user 34 may be provided with an option of registering for one or more services offered as part of the attendance monitoring system 10. After providing the required registration information, which may include payment information as described above, an account may be created and stored in the data repository 20. Based on the registration information completed by the interested party user 34, one or more users of the attendance monitoring system 10 may be created.

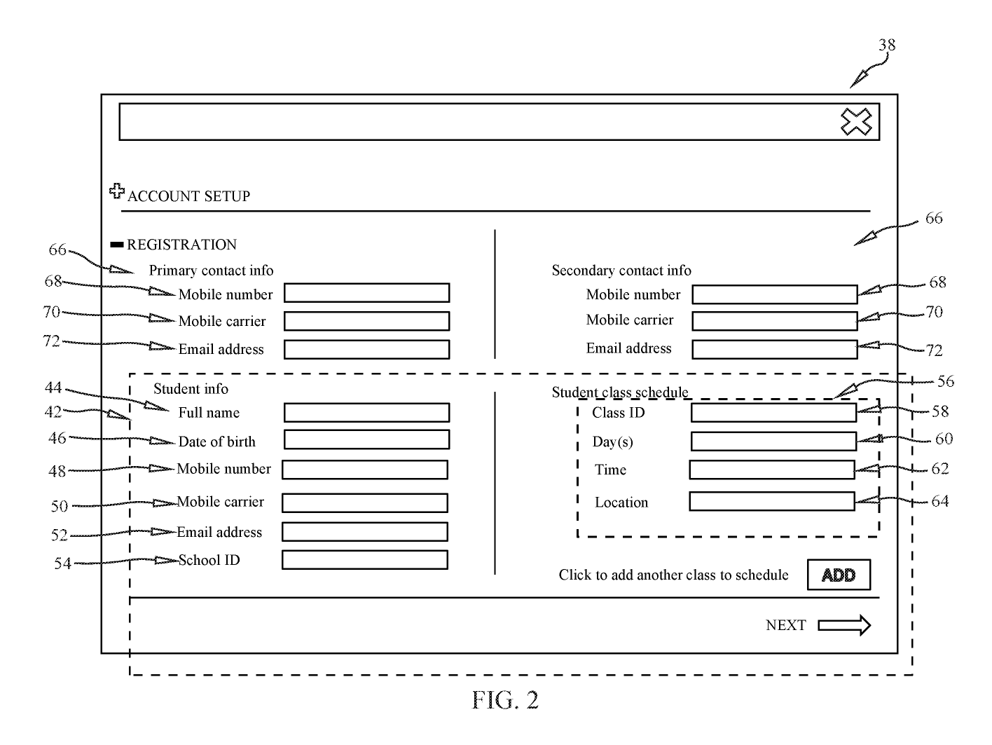

An exemplary display screen provided through a user interface of the user device 14 of the interested party user 28 during registration is shown at 38 in FIG. 2. Although the display screen 38 only depicts a portion of the information that might be collected during a registration process, FIG. 2 is provided to detail some relevant information that may be used by the attendance monitoring system 10. For example, the interested party user 28 registering for one or more of the services of the attendance monitoring system 10 may be prompted to enter information for a student user 40 whose class attendance is to be monitored. The information, which may represent a profile 42 for the student user 40, may include, for example, a name 44, date of birth 46, mobile number 48, mobile carrier 50, email address 52, and school identifier (ID) 54. The student profile 42 may also include information regarding a class schedule 56 for the student user 40. For example, the interested party user 28 may be prompted to enter a class identifier (ID) 58, day(s) 60, time 62, and location 64 for each class of the class schedule 56 for the student user 40. The day(s) 60 and time 62 may be correspond to or be used to derive a set of scheduled dates and times for the class 58 of the student's schedule 56. According to some embodiments, the class schedule 56 may also include a class duration for each class. Of course, additional and/or alternative information may be gathered, depending on the particular implementation.

The interested party user 28 may also be prompted to enter information for one or more interested party contacts 66, which may or may not include the interested party user 28 completing the registration. For example, some users may register to purchase a service of the attendance monitoring system 10 as a gift for one or more interested party contacts 66. The interested party contacts 66 may include persons selected or identified to receive notifications from the attendance monitoring system 10 pertaining to class attendance status for the student user 40. As should be appreciated, there exist a variety of interested parties, including, parents, instructors, counselors, athletic directors, coaches, and event leaders, to name a few. For each interested party contact 66, a mobile number 68, mobile carrier 70, email address 72, and/or additional or alternative information may be requested, depending on the electronic form of notification to be transmitted.

In an alternative embodiment, registration may be completed by an administrator 30 using one of the administrator devices 32, which may include any suitable electronic communication devices and/or workstations, such as, for example, personal computers, laptop computers, netbook computers, mobile devices, cell phones, smart phones, tablet devices, and wearable wireless devices, capable of interfacing with the server 12. The registration information, including information pertaining to accounts and/or users 28, may be stored in the data repository 20. Additionally, credentials for users 28 of the attendance monitoring system 10 may be stored in the data repository 20. Although the entire registration process may be completed at one time, the interested party user 34, or other party completing the registration, may access and complete different portions of the registration process at different times. The attendance monitoring system 10 may be configured to send reminders, as appropriate, requesting completion of required registration information.

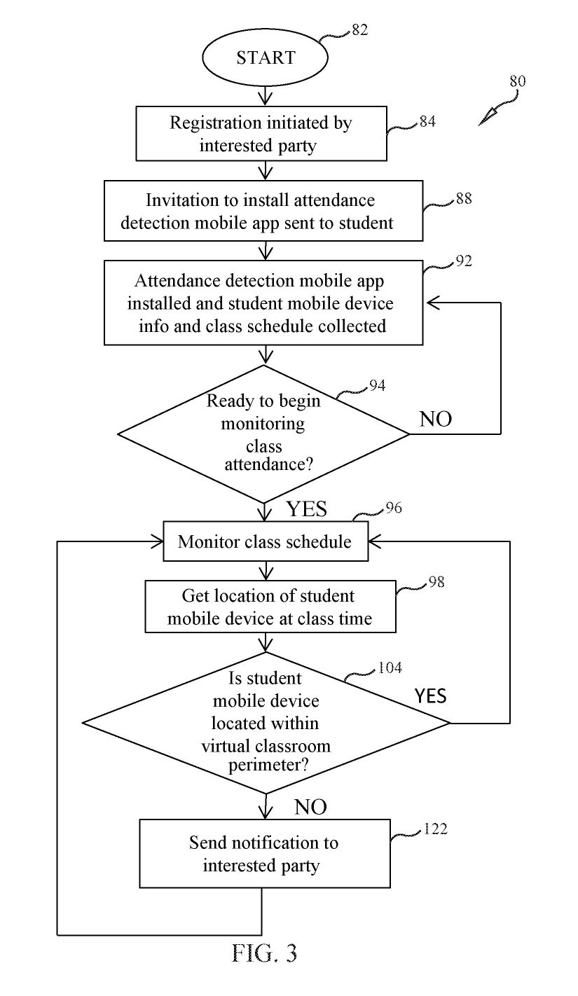

Various services, including an automatic attendance verification service and a manual attendance entry service, may be offered as part of the attendance monitoring system 10. If the registration by the interested party user 34 includes a selection and/or purchase of the automatic attendance verification service of the attendance monitoring system 10, a first exemplary method or process for monitoring class attendance may be invoked. Turning now to FIG. 3, and referring also to previous FIGS. 1 and 2, there is a shown a logic flow diagram representing an exemplary method 80 for monitoring class attendance using the automatic attendance verification service. All or portions of the method 80 may be facilitated and/or implemented using the attendance monitoring system 10 of the present disclosure. According to a specific example, some of the steps implementing the disclosed method 80 may be in the form of computer readable program code stored in the data repository 20 of the attendance monitoring system 10 and executed by the processor 18, or other computer usable medium. The method 80 may run continuously or may be initiated in response to one or more predetermined events.

The method 80 begins at a START, Box 82. From Box 82, the method 80 proceeds to Box 84, which includes a step of initiating the registration process. For example, as indicated above, the interested party user 34 may initiate and complete the registration process through the web browser 36 of the user device 14. Included in the registration process may be the entry of information pertaining to the student user 40, including, for example, mobile number 48, mobile carrier 50, email address 52, and class schedule information 56, as shown in FIG. 2. In addition to the student user profile information 42, the interested party user 34 may identify one or more interested party contacts 66 to be notified regarding the class attendance of the student user 40. For example, the one or more interested party contacts 66, which may or may not include the interested party user 34, may be notified when the student user 40 is absent from, present at, or tardy to a scheduled class.

After the registration by the interested party user 34, an electronic invitation to install an attendance detection mobile application 86 may be sent to the student user 40 using information provided in the student profile 42, as shown at Box 88. In particular, the attendance monitoring system 10 may send a text or email message to the student user 40 with information regarding the attendance monitoring system 10. For example, the electronic invitation may include a download link to simplify installation of the attendance detection mobile application 86. In addition, the student user 40 may be prompted to agree or consent to terms of use of the attendance monitoring system 10, particularly if the student user 40 is over the age of 18. As should be appreciated, some jurisdictions may have applicable regulations requiring the solicitation and receipt of consent.

Within the notification, the student user 40 may be given instructions to download the attendance detection mobile application 86 to their mobile device 90. In addition, the student user 40 may be provided with credentials for accessing and/or logging onto the attendance detection mobile application 86 and/or the website hosted by the server 12. It should be noted that the user manager module 24 may be tasked with ensuring the student user 40 is provided with appropriate access and capabilities within the attendance monitoring system 10 corresponding to the credentials of the student user 40. As should be appreciated, the interested party user 34 and the student user 40 may have different capabilities within the attendance monitoring system 10 and may have permissions to view different information.

Once the student user 40 has installed and logged into the attendance detection mobile application 86, and all required registration information has been received, at Box 92, the attendance monitoring module 26 may be operational with regard to the automatic attendance verification service portion of the attendance monitoring system 10 for the student user 40. That is, at Box 94, the method 80 may determine whether or not the required information has been collected and the required installations have occurred and, if not, the attendance monitoring system 10 or, more specifically, the attendance monitoring module 26, may send reminders to the appropriate parties to complete the requirements.

If, however, the attendance monitoring system 10 is ready to begin monitoring class attendance, the method proceeds to Box 96, and the attendance monitoring module 26 begins monitoring class schedules, including the class schedule 56 for student user 40. The processor 18 may be in electronic communication with the data repository 20 and the mobile device 90, such as, for example, through a network connection. The processor 18, in particular, may be configured to monitor the class schedules for each registered student, including the class schedule 56 for student user 40. That is, at the scheduled date and the scheduled time of a student's class, which may be associated with or derived from the meeting days 60 and times 62 entered during registration, the processor 18 might request a device location (i.e., transmit a device location request) from the mobile device 90 of the student user 40 using a mobile device identifier for the mobile device 90 stored in the profile 42 for the student user 40. The mobile device identifier may be, for example, the mobile number 48 and/or mobile carrier 50, the MAC, UUID, GUID or other universal device identifier of the mobile device 90, or another unique identifier stored by the attendance detection mobile application 86. For example, at Box 98, the server 12 may receive device location data associated with the mobile device 90 in response to a query transmitted through a network. In some embodiments, mobile device location data may include GPS coordinate data, latitude-longitude data, or a physical address.

The attendance detection mobile application 86 may include or utilize a geolocation application to obtain and transmit the present location of the mobile device 90. The geolocation application may use information provided by location detection hardware of the mobile device 90, for example, a GPS receiver 100, which receives position information from satellites 102, and/or a cellular transceiver to use information from cell towers to triangulate an approximate position of the mobile device 90. Alternatively, or additionally, the geolocation application may use location detection hardware of the mobile device 90 such as a Wi-Fi, Bluetooth, or other short-range radio transceiver or receiver in communication with a compatible radio network or other transmitter of known location, for example, Wi-Fi networks, to identify the location of the mobile device 90. It should be appreciated that any known method for locating devices may be used alone or in any of a variety of different combinations. In addition, the selected method(s) may change based on a number of variables, such as, for example, primary carrier cell coverage in an area, geographic obstructions, and weather issues. Exemplary geolocation applications are used by or include Foursquare, Facebook, and Google.

Upon receiving the mobile device location of the student's mobile device 90, the method 80 may compare the mobile device location data with the class location 64, or virtual perimeter, stored in the data repository 20. That is, the method 80, at Box 104, may determine if the student's mobile device 90, as indicated by the device location data, is located within the class, as indicated by the class location data 64, at the scheduled date 60 and scheduled time 62, according to the student's class schedule 56. It should be appreciated that class location data 64 entered during the registration process may be associated with or used to generate the class location data referenced above that is stored in the data repository 20 and used to determine class attendance according to the present disclosure.

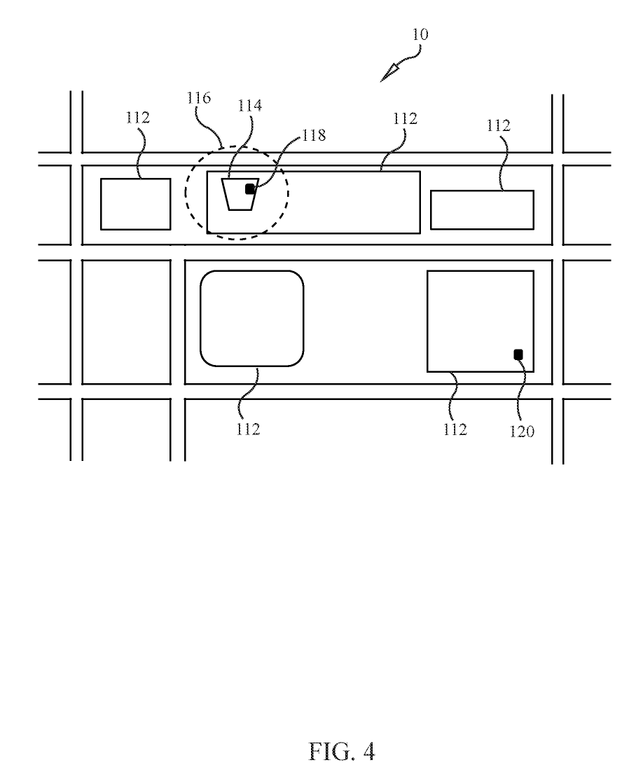

FIG. 4 depicts an exemplary map 110 for the college campus attended by student user 40. The campus map 110 includes buildings 112, which each include multiple classrooms. Classroom 114 may represent the class location 64 for a class student user 40 is scheduled to attend at the scheduled date 60 and the scheduled time 62. Perimeter 116 may represent a depiction of the class location data, or virtual perimeter, stored in the data repository 20, which corresponds to the class location 64, while point 118 may represent the location of student user's mobile device 90 at the scheduled date 60 and scheduled time 62. As depicted, the student user 40 is present, as indicated by the student's mobile device location 118, at the scheduled class 58.

If it is determined at Box 104 that the student user 40 is present for class 58, the attendance monitoring system 10 may be configured to store the results as an attendance status, such as a “present” status identifier, corresponding to this particular class 58. Such records may be stored in the data repository 20 and may correspond to the student profile 42. Thereafter, the method 80 may continue to monitor the class schedule 56 for student user 40 and additional student users of the attendance monitoring system 10. If, however, at Box 104, it is determined that the student user 40 is not present in the specified class 58 at the scheduled date 60 and scheduled time 62, as would be the case for alternative mobile device location 120 depicted in FIG. 4, the attendance monitoring system 10 may be configured to store alternative results in the data repository 20. For example, the attendance monitoring module 26 may store an “absent” or “not present” status identifier corresponding to the student profile 42 with regard to this particular class 58 (i.e., this particular meeting date and time for the class). In addition, the attendance monitoring system 10 may send a notification to the one or more interested party contacts 66, at Box 122. For example, the one or more interested party contacts 66 may be notified in real-time or near real-time that the student user 40 is not present for class 58.

As should be appreciated, the attendance notification system 10 may be configured in a variety of different ways depending on preferences. For example, the attendance monitoring module 26 may be configured to determine mobile device location on a predetermined frequency during the scheduled class period. That is, the attendance monitoring module 26 may request the mobile device location periodically, until the class duration expires. The mobile device locations may be compared to the class location information to determine a number of attendance statuses during the course of the class period. Any or all of these statuses may be stored and/or transmitted to the one or more interested party contacts 66. In addition, the stored statuses may be accessed and viewed by appropriate users, according to the rules and permissions established by the user manager module 24. For example, the student user 40, in addition to other users 28, may login to the attendance monitoring system 10 using a web browser 124 of mobile device 90 to view historical attendance data.

The virtual perimeters, such as perimeter 116, may be modified, or resized, based on collected mobile device location data, such as mobile device location 118. For example, the diameter of a virtual perimeter may be reduced if it is determined that all of the collected device location data occurs in an innermost region of the bounded area. Alternatively, a virtual perimeter could be shifted, or moved, if it is determined that the collected device location data reveals that mobile devices are always in only one half of the bounded area. Yet alternatively, the virtual perimeter size may be enlarged if it is determined that some device location data is very close, but not within, the virtual perimeter at required dates and times. Of course, the virtual perimeters may be resized in various ways, at various times, based on various data. Additionally, a separate virtual perimeter 116 may be used for each type of location detection hardware disclosed above as the locating accuracy may vary, for example, the accuracy of a GPS receiver 100 and a cellular transceiver of the mobile device 90 will likely be different.

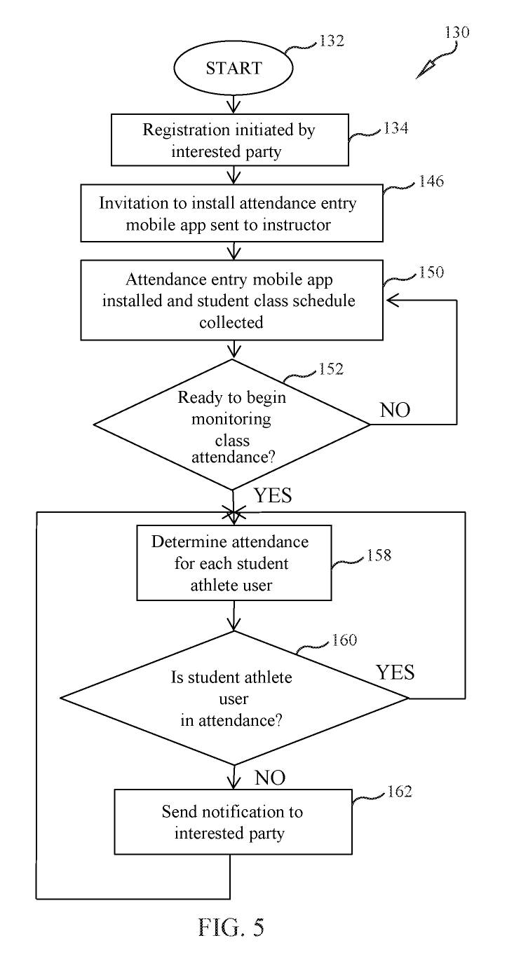

Turning now to FIG. 5, there is shown a logic flow diagram representing another exemplary method 130 for monitoring class attendance using the attendance monitoring system 10 of the present disclosure. In particular, the logic flow diagram represents the manual attendance entry service of the attendance monitoring system 10. All or portions of the method 130 may be facilitated and/or implemented using the attendance monitoring system 10 of the present disclosure. According to a specific example, some of the steps implementing the disclosed method 130 may be in the form of computer readable program code stored in the data repository 20 of the attendance monitoring system 10 and executed by the processor 18, or other computer usable medium. The method 130 may run continuously or may be initiated in response to one or more predetermined events.

The method 130 begins at a START, Box 132. From Box 132, the method 130 proceeds to Box 134, which includes a step of initiating the registration process. Some of the registration information described with reference to the automatic attendance verification service described above may also be collected for the manual attendance entry service. According to an example of the manual attendance entry service, an interested party user 136 may be a school administrator, coach, or member of the athletic department interested in monitoring class attendance for a student athlete user 138. For example, a coach or athletic director may want to monitor attendance for members of a particular team. The user manager module 24 may be configured to organize certain users into teams based on information input into the attendance monitoring system 10. The interested party user 136 may initiate and complete the registration process through, for example, a web browser 140 of the user device 14. Included in the registration process is the entry of student information and class schedule information, as described above. In addition to student user profile information, the interested party user 136 may be required to input instructor information for each class, including a mobile number, mobile carrier, and/or email address for an instructor user 142. Also, the interested party user 136 may identify one or more contacts to be notified regarding the class attendance of the student athlete user 138.

After registration, an invitation to install an attendance entry mobile application 144 may be sent to the instructor user 142, using information provided during the registration process, as shown at Box 146. In particular, the attendance monitoring system 10 may send a text or email to the instructor user 142 with information regarding the attendance monitoring system 10. In addition, the instructor user 142 may be given instructions to download the attendance entry mobile application 144 to their mobile device 148. Within the notification, the instructor user 142 may also be given credentials for accessing and/or logging into the attendance entry mobile application 144 and/or the website hosted by the server 12. For example, the user manager module 24 may be tasked with ensuring the instructor user 142 is provided with appropriate access and capabilities within the attendance monitoring system 10 corresponding to the credentials of the instructor user 142.

Once the instructor user 142 has installed and logged into the attendance entry mobile application 144, and all necessary registration information has been received, at Box 150, the attendance monitoring module 26 may be operational with regard to the manual attendance verification service portion of the attendance monitoring system 10 for the student athlete user 142. That is, at Box 152, the method 130 determines whether or not the required information has been collected and the required installations have occurred and, if not, the attendance monitoring system 10 or, more specifically, the attendance monitoring module 26, may send reminders to the appropriate parties to complete the requirements.

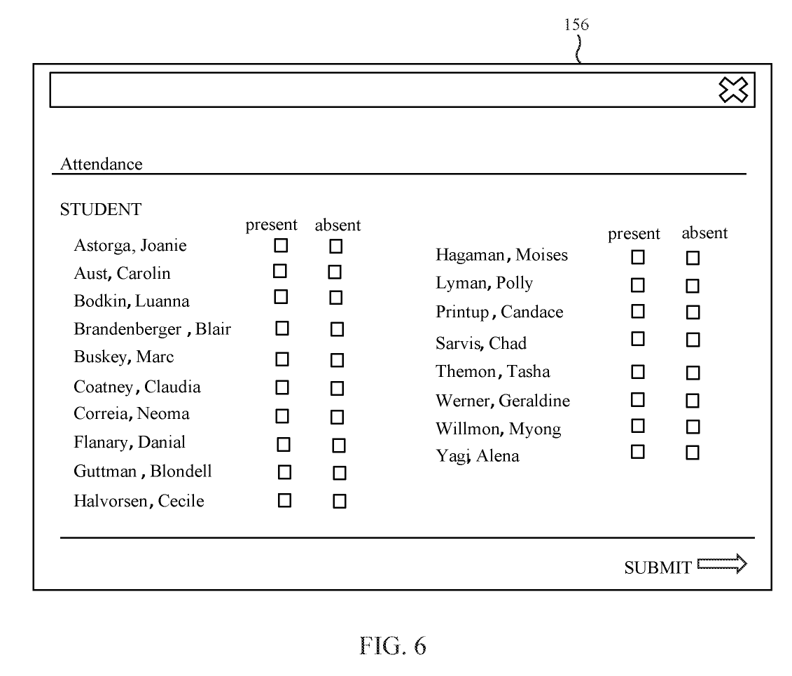

If the attendance monitoring system 10 is ready to begin monitoring class attendance, according to the manual attendance entry service, the method proceeds to Box 158 and class attendance information is collected based on manual entry. For example, as shown in FIG. 6, the instructor user 142 may input the presence or absence of each student using a roll call screen 156 of the attendance entry mobile application 144. If it is determined that the student athlete user 138 is present in class, at Box 160, the attendance monitoring system 10 may be configured to store a “present” status identifier corresponding to this particular class for the student profile. If it is determined, at Box 160, that the student athlete user 138 is not present in the specified class at the scheduled date and scheduled time, the attendance monitoring module 26 may store an “absent” or “not present” status identifier for the student profile with regard to this particular class. That is, the attendance entry mobile application 144, as part of the attendance monitoring system 10, may communicate with the server 12 and/or data repository 20 to store the attendance status information.

In addition, the monitoring system 10, based on the input via the attendance entry mobile application 144, may send a notification to one or more interested party contacts, as shown at Box 162. For example, one or more interested party contacts, which may include the interested party user 136, may be notified in real-time or near real-time that the student athlete user 138 is not present at the required class. The interested party user 136 may also access the information using the web browser 140. According to some embodiments, the instructor user 142 may access relevant information using a web browser 164 and/or may enter attendance information through the website using the web browser 164.

According to some embodiments, a “student only” service of the attendance monitoring system 10 may be offered, which monitors class attendance for students, such as student user 40 or student athlete user 138, as described herein. However, rather than providing notifications to third parties, such as interested party users 34 or 136, the notifications or correspondence provided as part of the attendance monitoring system 10 may be directed to the students themselves. Such a service may require administration or supervision by administrators 30, and may include the communication of personal messages, articles, or other information deemed suitable to notify the student of their attendance, inform the student of the strong link between class attendance and academic success, and encourage the student to improve his/her attendance. An identification of appropriate resources that may be available to the student may also be provided.

An attendance summary mobile application 170 may also be available for download to certain user devices 14, such as mobile devices 90, which may include any mobile electronic devices that can receive and transmit data through the network 16, including, for example, smart phones, tablet devices, and wearable wireless devices. For example, the interested party user 136 and student athlete user 138, among other users 28, may both install and utilize the attendance summary mobile application 170. Users 28 with the downloaded application 170 may enter their credentials and view relevant data from the attendance monitoring system 10, including attendance summary information for particular student users of interest. The information may be presented in a fashion most useful to the particular user type accessing the information.

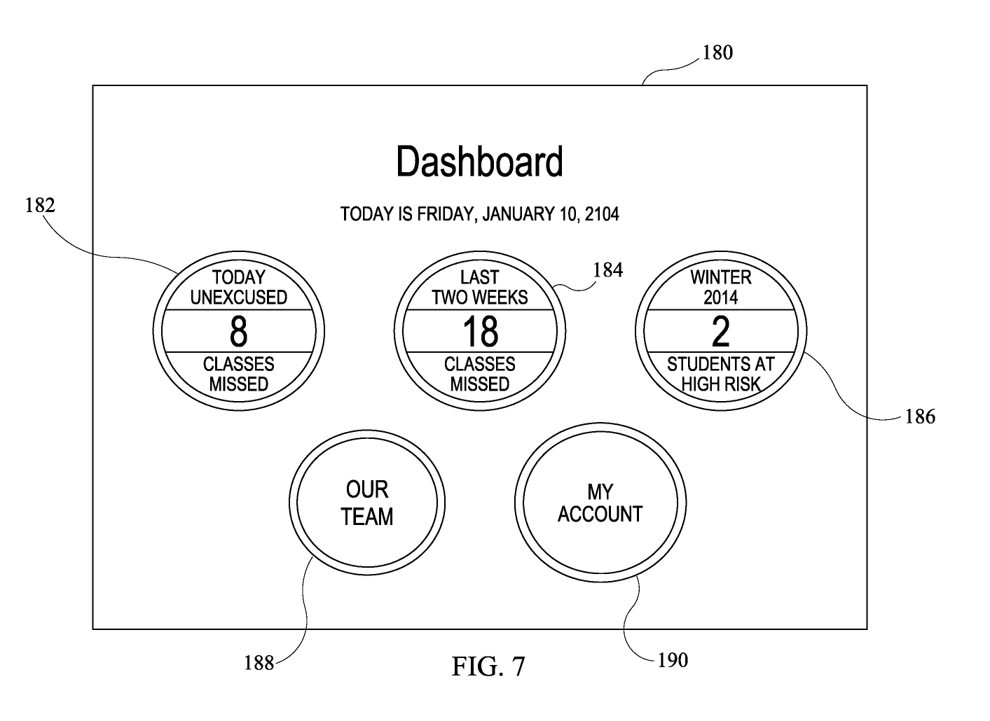

For example, as shown in FIG. 7, an athletic coach at an institution, such as interested party user 136, may log into the attendance summary mobile application 170 and see relevant information for members of a team associated with the coach on an exemplary attendance summary dashboard display 180. The coach may be interested in monitoring class attendance for all members of a relevant team, including, for example, student athlete user 138 and additional student athlete users. After logging into the attendance summary mobile application 170 the coach may be able to quickly and easily determine how many team members had unexcused absences from class that day, how many team members had unexcused absences in the past two weeks, and how many members of the team are considered “high risk.” In addition, the coach may be able to drill down to view details for each team member and information regarding identified team trends. The coach may also be able to access and modify user specific account information.

As shown, the dashboard display 180 may include a plurality of buttons 182, 184, 186, 188, and 190 that may display useful information and be actuatable by the coach or other personnel to invoke display of an additional screen display. For example, circular button 182 may display the number of team members that missed class on that particular day, and may also provide an indication of whether the current number of unexcused absences is trending better, worse, or the same relative to historical data. For example, a color or graphic may be presented and modified to convey such information. According to one example, if fewer team members missed class on the current day as compared to the previous day, a down arrow may be highlighted or displayed. Alternatively, the color red may be displayed somewhere on the button 182. Actuating the button 182 may initiate display of an identification of the specific team members that have missed class that day. Additional data regarding each team member may also be displayed, or may at least be easily accessible.

The additional buttons 184, 186, 188, and 190 may similarly display useful information and provide a link to an additional page or display upon which additional information may be provided. For example, buttons 184 and 186 may also be selected to reveal an identification of particular team members meeting the criteria described on the respective button. That is, button 184 displays the number of classes missed for the previous two weeks, while button 186 displays the number of students currently deemed “high risk.” It should be appreciated that the selection and organization of information to display and any applicable rules for selecting data may vary, depending on user preferences. For example, a team member may be determined to be “high risk,” according to rules established by the coach or athletic director. These rules may include an assessment of the number of absences overall or during a particular period of time. Button 188 may be selected to display information regarding members of the team, while button 190 may be actuated to view and/or modify details of the user's account.

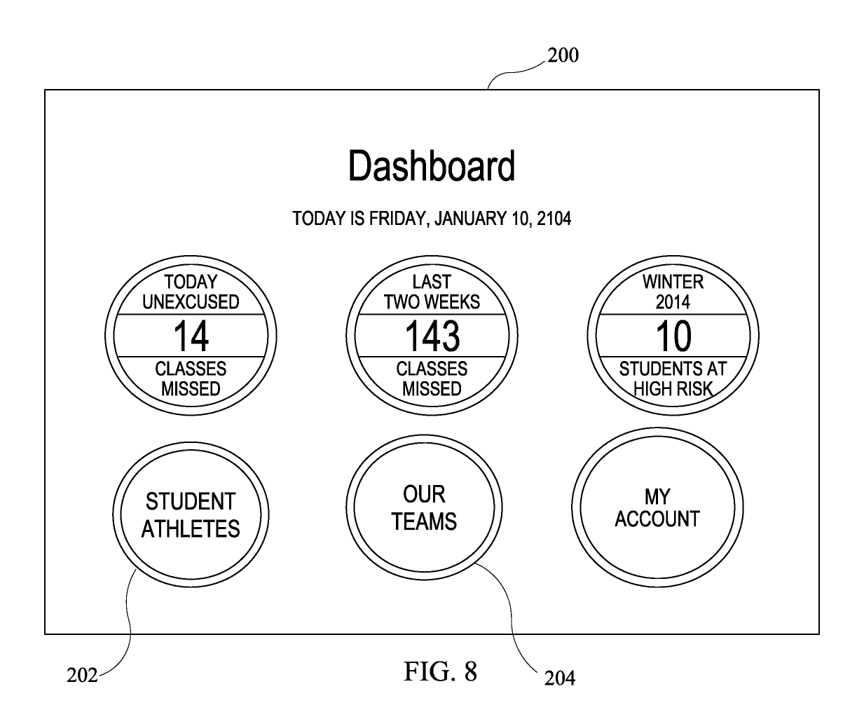

Another exemplary dashboard display 200, which may be provided for an athletic director, is shown in FIG. 8, and is similar to the dashboard display 180 of FIG. 7. That is, some of the same information identified as useful for a coach may also be useful to organize and display for the athletic director. However, the athletic director will likely be interested in monitoring class attendance for members of all of the teams at the college, as well as members of one specific team. Thus, in addition to some of the same information and capabilities described above, the athletic director may be provided with a specific option of viewing information for all student athletes, by actuating button 202, and viewing information for each of the school's teams, by actuating circular button 204. It should be appreciated, however, that the dashboard display 200 is provided for exemplary purposes only and is not intended to limit any portion of the implementation of the attendance monitoring system 10.

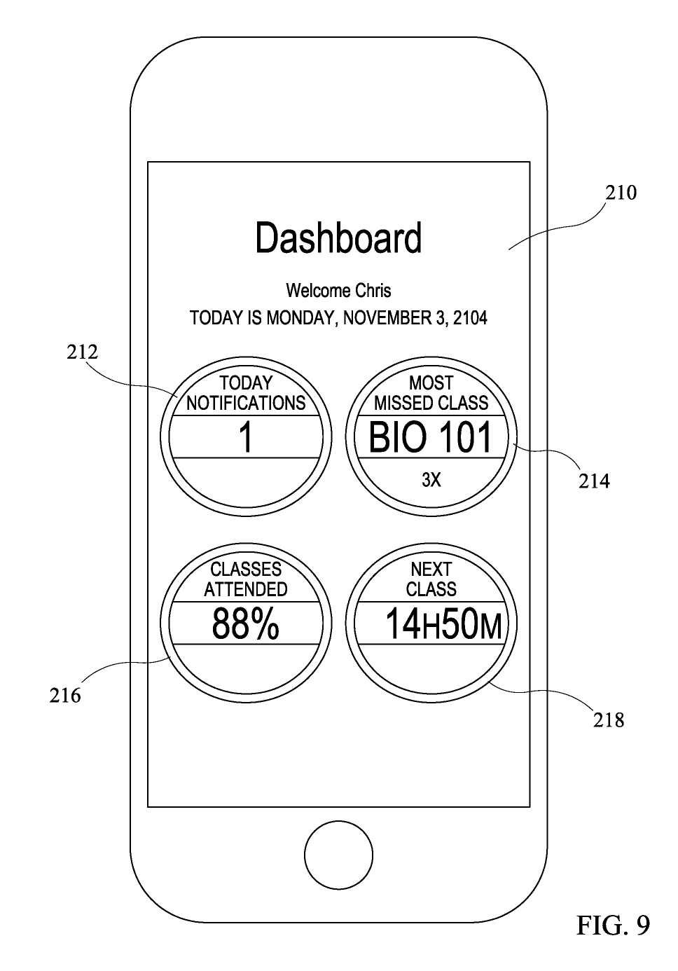

An exemplary student or parent dashboard display, depicted on a mobile device, is shown in FIG. 9 at 210. Obviously the student or parent dashboard display 210 displays information pertaining to the student of interest. The dashboard display 210 for the student or parent may easily identify the number of new notifications regarding the student's class attendance and the date on which the most recent notification was transmitted (on button 212). The dashboard display 210 may also identify the class that has been missed the most (on button 214), the percentage of classes the student has attended for a predetermined period of time (on button 216), and the number of hours and minutes until the student's next scheduled class (on button 218).

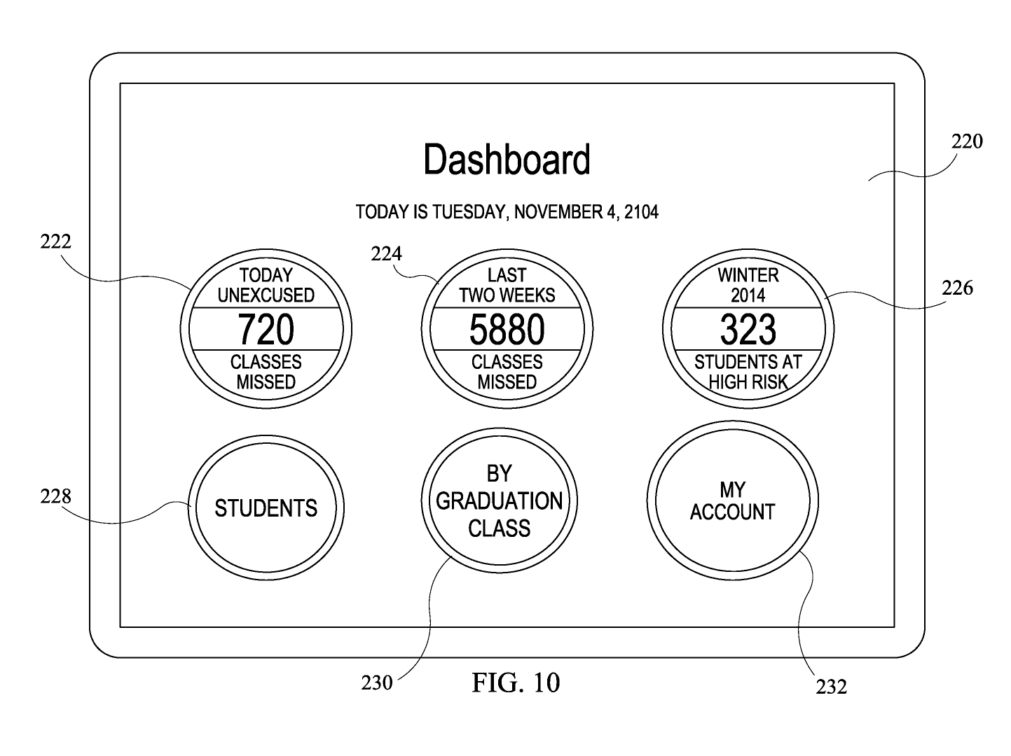

An exemplary college administrator dashboard display, depicted on a tablet device, is shown in FIG. 10 at 220. The dashboard display 220 may be similar to the dashboard display 200 of FIG. 8; however, a college administrator will likely be interested in monitoring class attendance for the entire school, rather than just for student athletes and/or particular teams. As such, circular button 222 may display the number of students that missed class on that particular day, button 224 may display the number of students that have missed classes over the previous two weeks, and button 226 may display the number of students determined to be high risk. As described above, actuating buttons 222, 224, and 226 permits “drilling down” and the revealing of additional details. The college administrator may also be provided with a specific option of viewing information for all enrolled students, by actuating button 228, and viewing information for each of the students by graduating class, by actuating button 230. Button 232 may be actuated to view and/or modify details of the college administrator's account.

The college administrator dashboard display 220, along with the other dashboard displays 180, 200, and 210, may additionally be accessed through the website. For example, any of the users 28 described above may access a relevant display screen through a respective web browser 140 or 190. As stated above, the information may be organized in a number of different ways to provide the most useful information to each of the particular users 28.

Additional features or services may be offered as part of the attendance monitoring system 10. For example, an additional service may be utilized to ensure the attendance monitoring module 26 does not monitor attendance and/or notifications are not transmitted when classes are not in session. For example, an additional service may receive schedule information and, based on the information received, update the attendance monitoring system 10 such that class attendance is not monitored on a holiday or other times when classes are not in session. Similarly, the attendance monitoring system 10 may be configured to receive indications regarding excused absences for one or more students and to receive inputs regarding emergency situations that results in class cancellations. In response, the services of the attendance monitoring system 10 should adapt accordingly.

According to an additional service, some interested party users, such as interested party users 34 and 136, may wish to send notification reminders, such as an email or text message, to student users, such as student user 40 and student athlete user 138, prior to class. Such a reminder may indicate to the student user 40 or 138 that a scheduled class time is approaching and/or may provide additional details regarding the student's class. Additional services are also contemplated and, like all of the services disclosed herein, have applicability to various facilities other than college campuses.

It should be appreciated that the attendance monitoring system 10 disclosed herein permits an interested third party, such as a parent or coach, having an interest in the academic success of a student, such as a child of the parent or a member of the coach's team, to initiate use of the attendance monitoring system 10. After the interested third party initiates use of the attendance monitoring system 10, such as by registering for and/or purchasing specific services, the student may be tasked with agreeing to terms of use of the attendance monitoring system 10 and/or installing necessary applications. The interested third party may identify themselves or others as recipients of notifications regarding the attendance of the student at scheduled classes. In addition to the notifications, and based on the rights provided to each user of the attendance monitoring system 10, the interested third party may view historical attendance information for one or more students.

Nowadays, almost all students have mobile devices that accompany them everywhere they go. This makes utilizing a student's mobile device location as an indication of whether or not the student is in attendance at their scheduled class highly reliable. The automated attendance monitoring system requests the mobile device location according to the class schedule and bases attendance on whether or not the mobile device location is within the system defined virtual perimeter representing the classroom. The virtual perimeter is dynamic, in that it might be modified or refined over time to improve accuracy. All of this monitoring and reporting occurs behind the scenes, without requiring any input from or interruption to students and faculty. The system automatically notifies and informs those parties having a stake in the academic success of the student regarding the student's class attendance.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A system for monitoring class attendance using a mobile device of a student, comprising:
a database storing a profile for the student including a mobile device identifier for the mobile device and a class schedule including a class identifier, a scheduled date, a scheduled time, and a class location;
an attendance detection mobile application installed on the mobile device, the mobile device including location detection hardware, the attendance detection mobile application obtaining and transmitting a mobile device location in response to a device location request; and
a processor in electronic communication with the database and the mobile device, the processor: monitoring the class schedule; at the scheduled date and the scheduled time requesting the mobile device location from the mobile device using the mobile device identifier; comparing the mobile device location to the class location; and determining and storing an attendance status corresponding to the class identifier and the student in the database based on the comparison.

2. The system of claim 1, wherein the class location includes a virtual perimeter bounding a set of geographical coordinates.

3. The system of claim 1, wherein the mobile device location may include one of GPS coordinate data, latitude-longitude data, and a physical address.

4. The system of claim 1, wherein the processor transmits an electronic invitation to install the attendance detection mobile application to the mobile device responsive to registration of the profile.

5. The system of claim 2, wherein the processor transmits an electronic notification to an interested party contact if the processor determines the mobile device location is not within the virtual perimeter.

6. The system of claim 2, wherein the virtual perimeter is resized based on a comparison of mobile device location and the virtual perimeter.

7. The system of claim 1, wherein the class schedule includes a class duration and the processor periodically, until the class duration is expired, requests the mobile device location from the mobile device using the mobile device identifier, compares the mobile device location to the class location, and stores an additional attendance status corresponding to the class identifier and the student in the database based on the comparison.

8. The system of claim 1, further comprising a user device of an interested party, the user device having a GUI displaying an attendance summary dashboard, and wherein the processor determines and communicates data relating to the attendance status of the student that is displayed by the attendance summary dashboard.

9. The system of claim 1, further comprising a user device of an interested party, the user device having a GUI displaying an attendance summary dashboard, and wherein the processor determines and communicates data relating to the attendance status of a selected group of students that is displayed by the attendance summary dashboard.

10. A method for monitoring class attendance using a mobile device of a student, comprising steps of:
storing in a database a profile for the student including a mobile device identifier for the mobile device and a class schedule that includes a class identifier, a scheduled date, a scheduled time, and a class location;
monitoring the database using a processor that is in electronic communication with the database and the mobile device;
at the scheduled date and the scheduled time, transmitting a request for a mobile device location from the processor to the mobile device using the mobile device identifier;
determining the mobile device location using location determining hardware of the mobile device in response to the request;
transmitting the mobile device location from the mobile device to the processor;
comparing the mobile device location to the class location using the processor; and
determining and storing an attendance status corresponding to the class identifier and the student in the database based on the comparing step.

11. The method of claim 10, further including installing an attendance detection mobile application on the mobile device, wherein the attendance detection mobile application obtains and transmits the mobile device location responsive to the request.

12. The method of claim 11, wherein the mobile device location may include one of GPS coordinate data, latitude-longitude data, and a physical address.

13. The method of claim 11, further including transmitting an electronic invitation to install the attendance detection mobile application to the mobile device from the processor responsive to registration of the profile.

14. The method of claim 10, wherein the class location includes a virtual perimeter bounding a set of geographical coordinates.

15. The method of claim 12, further including resizing the virtual perimeter based on the mobile device location.

16. The method of claim 10, further including the processor transmitting an electronic notification to an interested party contact if the processor determines the mobile device location is not within the virtual perimeter.

17. The method of claim 10, wherein the class schedule includes a class duration and the method steps are repeated periodically until the class duration is expired.

18. The method of claim 10, further comprising a step of determining data for an attendance summary dashboard for the student and the processor communicating the data to an interested party user device having a GUI for displaying the attendance summary dashboard.

19. The method of claim 10, further comprising a step of determining data for an attendance summary dashboard for a group of students and the processor communicating the data to an interested party user device having a GUI for displaying the attendance summary dashboard.

20. A system for monitoring class attendance for a plurality of students, comprising:
a database storing a profile for each of the plurality of students, each profile including a mobile device identifier for a mobile device and a class schedule including a class identifier, a scheduled date, a scheduled time, and a class location;
an interested party user device including a GUI displaying an attendance summary dashboard providing attendance status data for at least one of the plurality of students; and
a processor in electronic communication with the database, the interested party user device, and the mobile device of each of the plurality of students, the processor: monitoring the class schedules of the plurality of students; at the scheduled dates and scheduled times requesting mobile device locations from the respective mobile devices using the mobile device identifiers; comparing the mobile device locations to the class locations; determining and storing attendance status data corresponding to the class identifiers and the students in the database based on the comparisons, and communicating the attendance status data to the interested party user device.
